(19) United States
(12) Patent Application Publication
(10) Pub. No.: US 2023/0167931 A1
(43) Pub. Date: Jun. 1, 2023

(54) CONNECTION METHOD AND AXIAL ALIGNMENT MECHANISM

(71) Applicant: IHARA SCIENCE CORPORATION, Tokyo (JP)

(72) Inventors: Tetsuya YAMADA, Izunokuni-shi (JP); Tamie MORINAGA, Izu-shi (JP); Shota JIN, Mishima-shi (JP)

(21) Appl. No.: 17/799,071

(22) PCT Filed: Dec. 16, 2020
(86) PCT No.: PCT/JP2020/047025

§ 371 Date: Aug. 11, 2022

(30) Foreign Application Priority Data
Feb. 20, 2020 (JP) 2020-027024

(51) Int. Cl. F16L 23/08; F16L 23/00

(52) U.S. Cl. CPC F16L 23/08; F16L 23/003

(57) ABSTRACT

To make it possible to remove pipe members that are connected together by moving the pipe members in a radial direction, for example, without moving the pipe members in an axial direction, a pipe joint comprises a series of unit members each of which is rotatably connected to the adjacent one another and a fastener for connecting the unit members locating at both ends. A pair of the pipe members take a centering posture or a posture equivalent to the centering posture by engaging the flange portion of a pair of the pipe members with both axial sides of the unit members. A pair of the pipe members are connected together in the centering posture by connecting the unit members locating at both ends using the fastener so as to make the unit members in an annular state and by fastening the fastener.

### FIELD OF THE ART

This invention relates to a connection method and an axial alignment mechanism for connecting a pair of pipe members.

### BACKGROUND TECHNOLOGY

Conventionally, as a fluid control device used in a semiconductor control device, there are various fluid control units that are arranged in a manifold in which an internal flow channel is formed, as shown in a patent document 1 and a patent document 2. However, there is a problem that such a fluid control device becomes heavy due to the use of the manifold, and the cost of processing the internal flow channels becomes also high, and an internal flow channel becomes long, resulting in increasing resistance and requiring a large source pressure.

In contrast, as shown in patent documents 3 through 5, if pipe joints are used for connecting ports and pipes or for connecting pipes to each other of the fluid control unit, it is possible to eliminate manifolds. For convenience of explanation, the ports of the fluid control unit such as flow meters or various sensors, in addition to the piping itself, are hereinafter collectively referred to as pipe members.

It is known that an example of the pipe joint, as shown in the patent document 3, comprises a series of unit members each of which is rotatably connected to the adjacent one another and a fastener for connecting the unit members locating at both ends, and the unit members locating at both ends are connected by the fastener to form an annular state, and the fastener is tightened to connect a pair of the pipe members together.

More concretely, first, the pipe members are centered by inserting one pipe member into the ring-shaped member called a center ring from one side in the axial direction, and by inserting the other pipe member into the center ring from the other side in the axial direction. Then, a pair of the pipe members are connected by the above-mentioned unit member in a state wherein a pair of the pipe members are inserted into the center ring.

However, in case that one of the joined pipe members is to be removed from the pipe joint, for example, during maintenance of a fluid control unit, it is necessary to pull out the pipe member from the center ring by moving the pipe member in the axial direction. This requires securing space for pulling out the pipe member so that there is a limit to downsize the device or to integrate the fluid control unit.

### PRIOR ART DOCUMENT

### Patent Literature

Patent document 1: U.S. Pat. No. 6,685,234
Patent document 2: Patent Publication No. 2002-89798
Patent document 3: U.S. Pat. No. 4,942,332
Patent document 4: Utility model registration No. 3175176
Patent document 5: U.S. Pat. No. 5,722,645

### DISCLOSURE OF THE INVENTION

### Problems to be Solved by the Invention

The present claimed invention has been made to solve the above-mentioned problems, and a main object of this invention is to make it possible to remove the pipe members that are joined together by moving the pipe members, for example, in the radial direction without moving them in the axial direction.

### Means to Solve the Problems

More specifically, the connection method in accordance with this invention is a connection method for connecting a pair of pipe members by means of a pipe joint, and is characterized by that the pipe joint comprises a series of unit members each of which is rotatably connected to the adjacent one another and a fastener for connecting the unit members locating at both ends, a pair of the pipe members take a centering posture or a posture equivalent to the centering posture by engaging a flange portion of each of a pair of the pipe members with both axial sides of the unit members, and a pair of the pipe members are connected together in the centering posture by connecting the unit members locating at both ends using the fastener so to make the unit members in an annular state and by fastening the fastener.

In accordance with this connection method, since a pair of the pipe members take the centering posture or a posture equivalent to the centering posture by engaging the flange portions of a pair of the pipe members with both axial sides of the unit members, it is possible to make a pair of the pipe members centered without using a conventional ring-shaped member.

Since there is no need of ring-shaped member to remove the jointed pipe members, it is possible to remove the pipe members by moving them, for example, in the radial direction without moving them in the axial direction, thereby downsizing a gas panel and increasing the integration of a gas panel in which this pipe joint is used.

As a more concrete embodiment, it is preferable that either of a groove portion extending in a circumferential direction or a convex portion extending in the circumferential direction is arranged on the flange portion of a pair of the pipe members, the other of the groove portion extending in the circumferential direction or the convex portion extending in the circumferential direction is arranged on both axial sides of at least one of the unit members, and a pair of the pipe members take the centering posture or the posture equivalent to the centering posture by engaging either of the groove portion and the convex portion arranged in the flange portion of each of a pair of the pipe members with the other of the groove portion or the convex portion arranged in the unit members.

In accordance with this configuration, it is possible to make a pair of the pipe members take the centering posture or a posture equivalent to the centering posture by engaging either of the groove portion or the convex portion arranged on the flange portion of each of a pair of the pipe members with the other of the groove portion or the convex portion arranged on the unit member.

In order to make it possible to produce the above-mentioned operation and effect remarkably, it is possible that a pair of the pipe members take the centering posture or the posture equivalent to the centering posture by engaging the groove portion with the convex portion with a movement of the pipe member along the radial direction of the pipe member toward the unit member or a movement of the unit member along the radial direction of the pipe member toward the pipe member.

It is preferable that the groove portions are arranged on each of the flange portions of a pair of the pipe members, the convex portions are arranged at both axial sides of the unit members, a surface of the groove portion opposite to the convex portion and a surface of the convex portion opposite to the groove portion are inclined surfaces in a state wherein the groove portion and the convex portion are engaged, the inclined surface of the groove portion and the inclined surface of the convex portion are pressed against each other by connecting the unit members locating at both ends using the fastener and by fastening the fastener and the flange portions of a pair of the pipe members are crimped and connected by a component force in the axial direction that generates at a time of fastening the fastener.

In accordance with this configuration, it is possible to securely join a pair of the pipe members together airtightly and liquid-tightly. The flange portions do not necessarily have to be in contact with each other, and it is more preferable that the flange portions are crimped through a sealing member such as a gasket.

Furthermore, a connection method in accordance with this invention is a connection method characterized by comprising a process for preparing a pipe joint that comprises a series of unit members of which adjacent unit members are rotatably connected to each other and a fastener for connecting the unit members locating at both ends, wherein an inclined surface for producing a wedge effect by fastening the fastener is formed on an inner circumferential surface of the unit member, a process for preparing a pair of pipe members having an inclined surface opposite to the inclined surface of the unit member, a process for confirming that a pair of the pipe members take a centering posture or a posture equivalent to the centering posture, and a process for connecting a pair of the pipe members by the fastener.

In accordance with this connection method, since there is a process for confirming that a pair of the pipe members are in a centering posture or a posture equivalent to the centering posture, centering can be performed without using a conventional ring-shaped member.

In addition, an axial alignment mechanism in accordance with this invention is an axial alignment mechanism in case of connecting a pair of pipe members by means of a pipe joint, and is characterized by having a configuration that the pipe joint comprises a series of unit members of which adjacent unit members are rotatably connected to each other and a fastener for connecting the unit members locating at both ends, wherein comprising a groove portion that is arranged in one of (i) the flange portion of a pair of the pipe members or (ii) at least one of the unit members and that extends in a circumferential direction, and a convex portion that is arranged in the other of (i) the flange portion of the pair of the pipe members or (ii) at least one of the unit members and that extends in the circumferential direction and that engages with the groove portion, and a pair of the pipe members are so configured to take a centering posture or a posture equivalent to the centering posture by engaging the groove portion with the convex portion.

In accordance with this configuration of the axial alignment mechanism, since a pair of the pipe members take the centering posture or the posture equivalent to the centering posture by engaging the groove portion with the convex portion, it is possible to center the pipe members without using a conventional ring-shaped member and to produce the same operation and effect as that of the above-mentioned connection method.

In order to produce the above-mentioned operation and effect more remarkably, it is preferable that the axial alignment mechanism is configured without using a member by which a pair of the pipe members are fitted from the axial direction.

In the background art, the pipe joint (hereinafter referred to as a clamp type joint) explained in the patent document 3 as an example is proposed as a connection method for connecting a pair of pipe members.

On the other hand, a fluid control device (hereinafter referred to as a gas panel device, or simply a GP device for short) has conventionally been proposed for supplying and exhausting various reaction gases to and from a reaction chamber of a semiconductor manufacturing device such as, for example, a semiconductor vapor phase growth device. A typical example of such a GP device is given in the patent document 2. As can be seen from the figure in the patent document 2, various block-shaped manifolds locating below various flow control units are used to connect a flow channel between the various flow control units such as the various sensors like flow meters or valves constituting the GP device. Therefore, as can be seen from a plan view of the entire GP device, a distance between the fluid control units is so close that the flow control units are almost closely spaced, and a high degree of integration is used in practical applications.

Although the degree of integration for the GP device that uses such blocks and manifolds (hereinafter referred to as “manifold-type GP device”) in a plane view has been increased to the utmost limit, there are problems that the structural features of the manifolds and blocks, which are arranged vertically, increase the overall weight of the GP device, the space occupied by the GP device in the vertical direction is large, flow channel resistance increases and required source pressure increases accordingly, the manifold processing cost increases, and (in particular, the sealing mechanism between each of the fluid control devices has to be precisely machined to prevent leakage).

On the other hand, the patent document 1 discloses a nut-type joint structure, wherein right and left pipe members can be shifted in a direction perpendicular to a flowing direction of a fluid by dismounting the pipe member with rotating a nut counterclockwise. However, in accordance with the configuration disclosed by the patent document 1, there is a problem that space is required for axial movement of the nut, and it is difficult to adopt this type of joint, especially for a GP device that requires integration. As a joint that significantly improves this problem, there is a clamp type joint shown in the patent document 3 through the patent document 5.

However, since a center ring is an essential element of this clamp type joint, in case of dismounting the center ring after releasing the clamp, it is necessary to move the pipe member in the axial direction or detach the center ring from one of the pipe members, although not as much as the nut in the above-mentioned patent document 1. This means that some space between a pair of the opposing fluid control devices is required for the centering operation.

In addition, in case that the operation of inserting the center ring into a pair of the pipe members to assemble a pair of the pipe members cannot be done correctly (for example, when there is misalignment), it is necessary to recheck and correct a support base and its processing and assembly accuracy at least in an adjacent area. Considering that dozens of joints are used in the above-mentioned GP device, the entire GP device manufacturing process is delayed, backtracking of work is caused, and unnecessary cost is incurred.

The inventors of the present claimed invention have found that the clamp type joint shown in the patent document 3 through the patent document 5 has an advantage of not having the above-mentioned problems of the manifold type GP devices. However, the fact that the clamp type joint requires a certain extent of space for centering operation in addition to the space of the joint between a pair of the opposed fluid control devices is one of the reasons why it is difficult to adopt the clamp type joint method to GP devices. As a result of keen examination to solve the problem, the inventors have focused on the centering function of the center ring.

More specifically, regarding GP devices of the clamp type joint, the inventors have found out that the above-mentioned problem can be solved fundamentally by providing a step to measure an amount of misalignment of connection ports of a pair of the fluid control devices arranged opposite to each other prior to a fastening operation of a pair of the pipe members by a clamp ring, and to determine that the value is within an allowable value to an extent that the subsequent fastening operation by the clamp ring can be performed normally.

Accordingly, a connection method for connecting a pair of pipe members of a GP device in accordance with this invention is a method for connecting connection ports of a pair of fluid control units arranged opposite to each other in a flowing direction of a fluid of the fluid control device (the GP device) wherein a plurality of fluid control units are integrated and arranged on a substrate, and comprises a process of preparing a joint body that comprises a series of unit members that are rotatably connected to each other and a fastening device that fastens both end portions of the unit members and in which an inclined surface that produces a wedge effect in accordance with a movement of fastening the unit members is formed on an inner circumferential side of each of the unit members, a process of preparing a pair of the pipe members at one end side of which a flange portion is formed and the other end side of which is connected to a connection port side of a pair of the fluid control units, and an opposite inclined surface that makes engagement with the inclined surface formed on the inner circumferential side of the unit member is formed on the flange portion, a process of arranging a pair of the fluid control units and members to support the fluid control units so as to make a posture in the axial direction of the connection port of a pair of the fluid control devices opposed to each other in almost a centering state and confirming that a pair of the flange portions are in a state of being able to be engaged with the unit member, and subsequently to the above-mentioned process for confirmation, a process of engaging the inclined surface of the flange portion of a pair of the pipe members with the opposite inclined surface of the inner circumferential side of the unit member and performing a fastening movement due to the fastening device.

### Effect of the Invention

In accordance with the above-mentioned invention, it is possible to center a pair of the pipe members without using a conventional ring-shaped member. In case of removing the pipe members that are connected together, the pipe members can be removed, without moving the pipe members in the axial direction, for example, by moving the pipe members in the radial direction so that it is possible to downsize and highly integrate the gas panel wherein this pipe joint is used.

### BRIEF DESCRIPTION OF THE DRAWINGS

FIG. 1 is a cross-sectional view of a pipe member in one embodiment of this invention.

FIG. 2 is a cross-sectional view of a pipe member, a gasket, and a pipe joint in this embodiment.

FIG. 3 is a cross-sectional view of the pipe joint in this embodiment.

FIG. 4 is a perspective view of the pipe joint in this embodiment.

FIG. 5 is a cross-sectional view showing a configuration of an axial alignment mechanism in this embodiment.

FIG. 6 is a cross-sectional view showing the configuration of the axial alignment mechanism in this embodiment.

FIG. 7 is a schematic diagram showing a configuration of a friction force generating member in this embodiment.

FIG. 8 is a schematic diagram showing a configuration of a gas panel using a pipe joint in this embodiment.

FIG. 9 is a schematic diagram showing a process for mounting the gasket on the pipe member in this embodiment.

FIG. 10 is a schematic diagram showing a process for connecting a pair of the pipe members in this embodiment.

FIG. 11 is a schematic diagram showing the process for connecting a pair of the pipe members in this embodiment.

FIG. 12 is a schematic diagram showing the process for connecting a pair of the pipe members in this embodiment.

FIG. 13 is a schematic diagram showing a configuration of the pipe members and the pipe joint in other embodiments.

### EXPLANATION OF CHARACTERS

1 . . . pipe member
11 . . . body portion
12 . . . flange portion
13 . . . port
14 . . . projection
15 . . . groove portion
16 . . . bottom surface
17 . . . side surface
18 . . . side surface
2 . . . gasket
21 . . . hole
4 . . . gasket holder
41 . . . one end opening
42 . . . other end opening
43 . . . claw portion
3 . . . pipe joint
31 . . . unit member
32 . . . fastener
33 . . . concave groove
34 . . . inclined surface
35 . . . convex portion
5 . . . axial alignment mechanism
6 . . . friction force generating member

### BEST MODES OF EMBODYING THE INVENTION

One embodiment of this invention will be described below with reference to drawings.

First, a pipe member 1, a gasket 2, and a pipe joint 3 in accordance with this embodiment will be explained.

<Pipe Member 1>

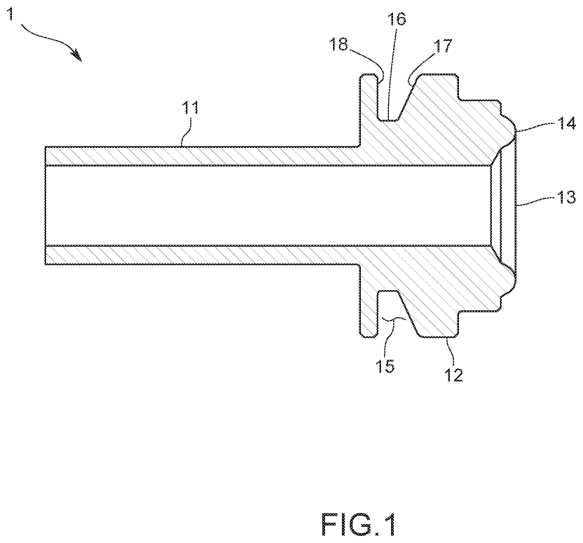

As shown in FIG. 1, the pipe member 1 has a body portion 11 and a flange portion 12 arranged at an end of the body portion 11, and a fluid flows in an inside of the pipe member 1. Although the pipe member 1 in this embodiment is a pipe, the pipe member 1 may be another form, for example, such as a tubular connection portion to which a pipe is connected in a fluid control unit such as a flow meter or various sensors (more specifically, a portion where a connection port to which a pipe is to be connected).

The flange portion 12 has a port 13 through which the fluid flows in or out and is a portion to be connected by a pipe joint 3, to be described later. The flange portion 12 in this embodiment has a larger outer diameter than that of the body portion 11 and is provided with a circular projection 14 at a distal end surface thereof (hereinafter also called as an opposite surface).

Then, the flange portion 12 is provided with a groove portion 15 extending in a circumferential direction of the flange portion 12, as shown in FIG. 1. The groove portion 15 is arranged over an entire circumference of the flange portion 12. Concretely, the groove portion 15 is a space surrounded by a bottom surface 16 extending in the circumferential direction and a pair of side surfaces 17, 18 arranged on both axial sides of the bottom surface.

At least one of a pair of the side surfaces 17, 18 that forms the groove 15 is an inclined surface. The inclined surface converts a given radial force into an axial force and generates a component force in the axial direction, and in this embodiment, the side surface 17 located on a front side among a pair of the side surfaces 17 and 18 is inclined so that the diameter gradually increases toward the front side.

In case of inclining the side surface 18 located on a rear side among a pair of the side surfaces 17 and 18, the inclined surface may have the diameter that gradually increases toward the rear side.

<Gasket 2>

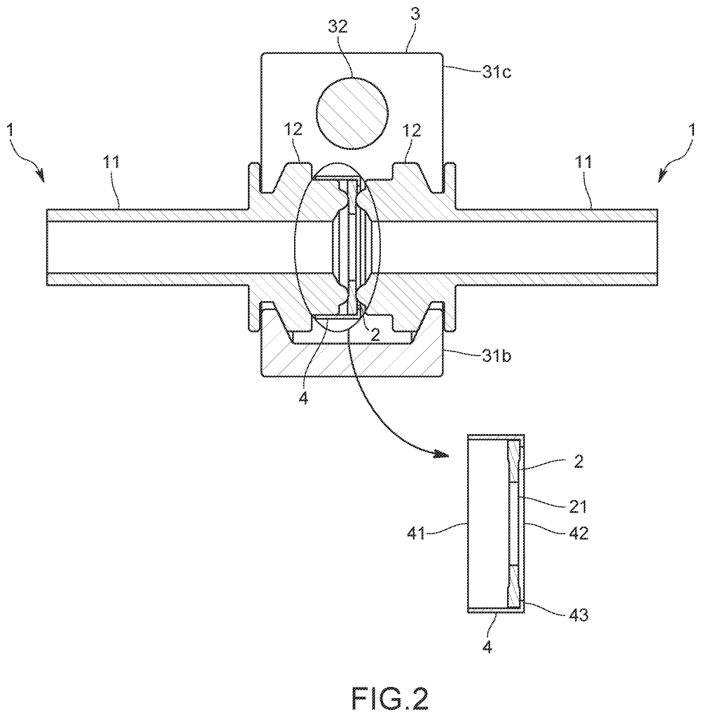

As shown in FIG. 2, the gasket 2 is a sealing member that lies between a pair of the pipe members 1, more specifically between the flange portions 12 of each of a pair of the pipe members 1 to secure sealing performance between the pipe members 1. Concretely, the gasket 2 is a circular plate with a hole 21 formed in a center for flowing the fluid and is held by a cylindrical gasket holder 4 in this embodiment.

As shown in FIG. 2, the gasket holder 4 accommodates the gasket 2 which is placed inside of the gasket holder 4 through one end opening 41, and a claw portion 43 to prevent the accommodated gasket 2 from slipping out is arranged in an inner edge part of the other end opening 42.

In accordance with this this configuration, as shown in FIG. 2, the gasket 2 is arranged at a distal end portion of the pipe member 1 by mounting the gasket holder 4 on the flange portion 12 of one of the pipe members 1 in a state wherein the gasket 2 is accommodated in the gasket holder 4.

Then, the projection 14 formed on the distal end surface of each of a pair of the pipe members 1 bites into the gasket 2 by crimping the distal end surfaces of a pair of the pipe members 1 in a state wherein the distal end surfaces are opposite to each other so that airtightness between the distal end surfaces of a pair of the pipe members 1 is secured.

<Pipe Joint 3>

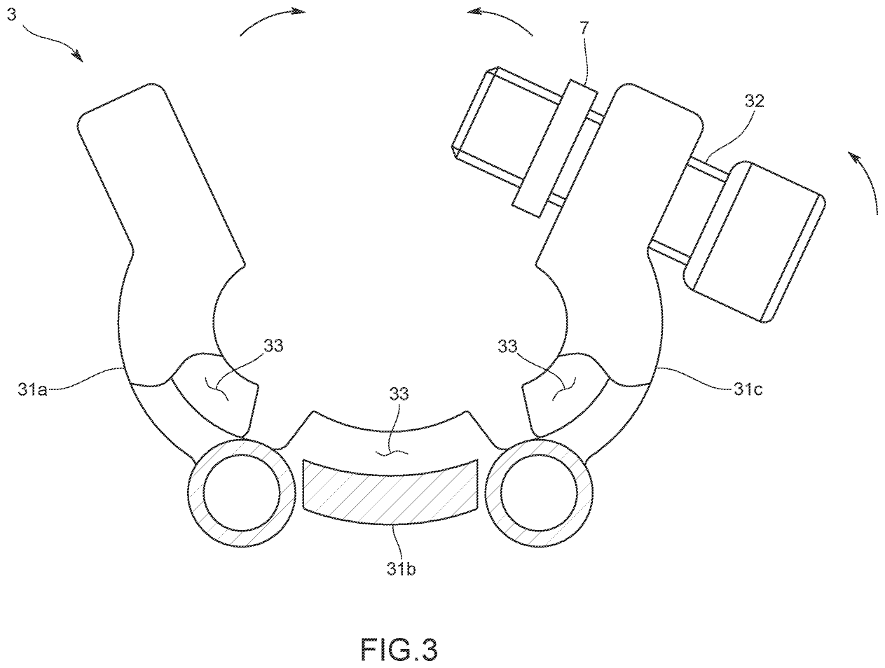

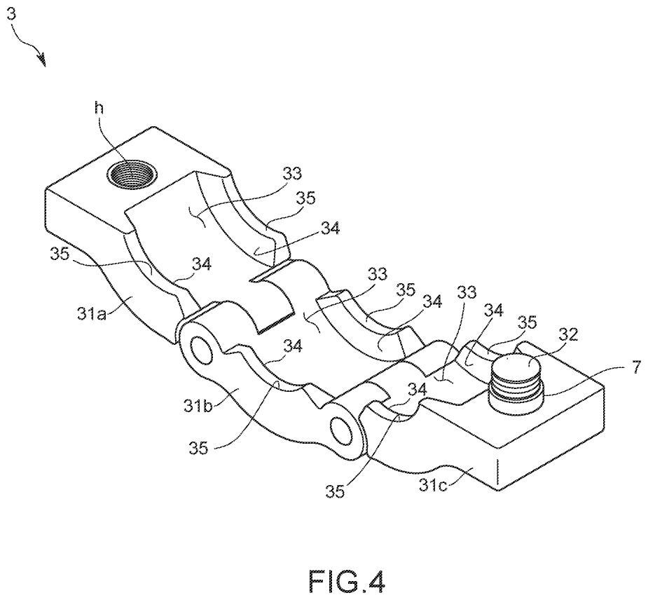

The pipe joint 3 is to fasten and connect the flange portions 12 by fitting over the flange portions 12 of a pair of the pipe members 1 in a state wherein the distal end surfaces of the flange portions 12 are opposite to each other. As shown in FIG. 3 and FIG. 4, the pipe joint 3 comprises a plurality of unit members 31a through 31c (three in this embodiment) that are fitted over the flange portions 12, and a fastener 32 that makes a series of the unit members 31a through 31c in an annular shape by connecting the unit members 31a and 31c locating at both ends.

In this embodiment, the unit members 31a through 31c are shaped as a circular ring divided into three parts when viewed from the axial direction. As shown in FIG. 3 and FIG. 4, a concave groove 33 that has a width enough to be fitted over an outer circumferential portions of each of a pair of the flange portions 12 opposite to each other and that extends in the circumferential direction is provided on an inner circumferential surface of each of the unit members 31a through 31c, and inclined surfaces 34 corresponding to the inclined surfaces 17 of the flange portions 12 are formed on a side surface of the concave groove 33.

Thus, as shown in FIG. 4, convex portion 35 that extends in the circumferential direction is arranged on the unit members 31a through 31c.

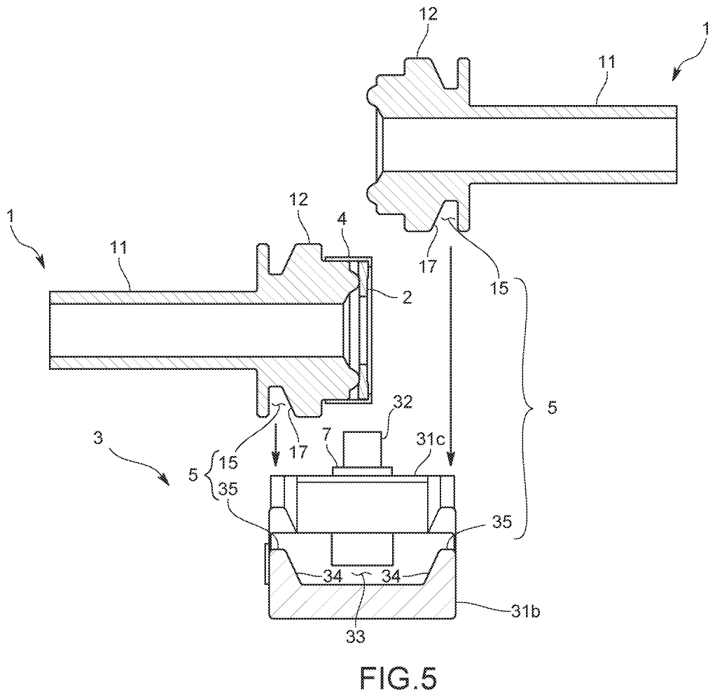

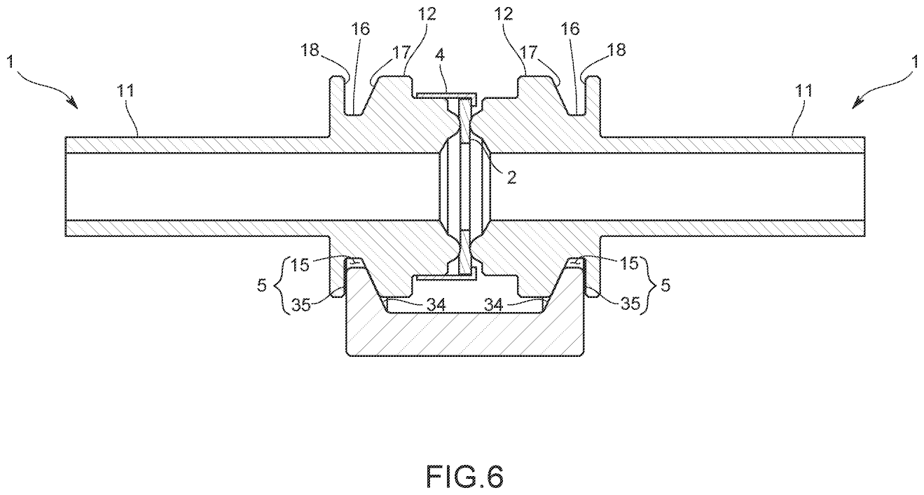

As shown in FIG. 5 and FIG. 6, the convex portion 35 is to engage with the groove portion 15 arranged in the flange portion 12 of the pipe member 1 and constitutes an axial alignment mechanism 5 together with the groove portion 15 for positioning the pipe axes of a pair of the pipe members 1 on the same line.

The axial alignment mechanism 5 is designed to enable centering a pair of the pipe members 1 without moving a pair of the pipe members 1 in the axial direction and is so configured not to use a member into which the pipe members 1 are fitted from the axial direction. Concretely, as shown in FIG. 5 and FIG. 6, the axial alignment mechanism 5 is so configured to take a centering posture wherein a pair of the pipe members 1 are centered, or a posture that is equivalent to this centering posture by making the convex portion 35 approach the groove portion 15 in the radial direction of the pipe members 1 and engage with the groove portion 15. The posture equivalent to the centering posture means that the pipe axes of a pair of the pipe members 1 are not completely on the same line and are slightly inclined toward each other, but the centering posture is achieved by fastening the unit members 31a through 31c to be an annular shape.

More specifically, as shown in FIG. 5 and FIG. 6, each of the above-mentioned convex portions 35 is arranged to correspond to each of the flange portions 12 of a pair of the pipe members 1 respectively. In this embodiment, a pair of the convex portions 35 are arranged on each of both axial sides of the concave grooves 33 of each of the unit members 31a through 31c, and the opposite surfaces of the convex portions 35 are the side surfaces of the above-mentioned concave grooves 33 and the opposite inclined surfaces 34.

A pair of the convex portions 35 are arranged, as shown in FIG. 4, in a series of the unit members 31a through 31c respectively so as to make it possible for the groove portions 15 of the flange portion to engage with the convex portions 35 of any unit members 31a through 31c.

In accordance with this configuration, the distal end surfaces of a pair of the pipe members 1 make an abutting contact with each other through the above-mentioned gasket 2 and a pair of the pipe members 1 are placed to take the centering posture or a posture equivalent to the centering posture by engaging the groove portion 15 of the flange portion 12 with the convex portion 35 of the unit members 31a through 31c.

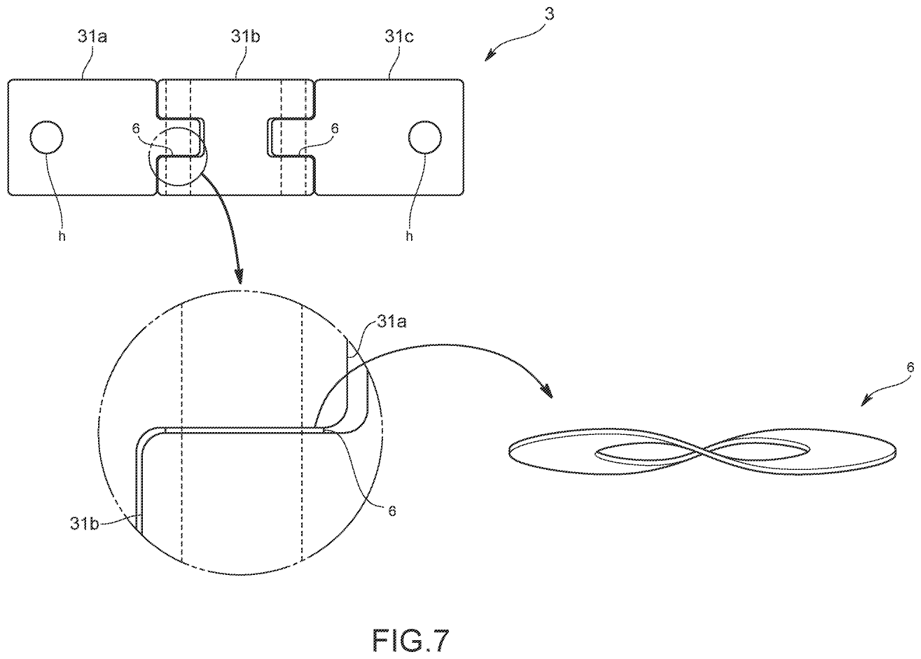

In addition, as shown in FIG. 7, the pipe joint 3 in accordance with this embodiment further comprises a frictional force generating member 6 such as a wave washer that is placed between mutually adjacent unit members 31a through 31c and that generates a fictional force that prevents rotation of the unit members 31a through 31c.

The pipe joint 3 is so configured to keep the posture of the unit members 31a through 31c by the frictional force unless an external force is applied to the unit members 31a through 31c. In accordance with this configuration, it is possible for a user to adjust the expansion angle of the unit members 31a though 31c adjacent to each other continuously by the frictional force, and a spread angle (more specifically, postures) of a series of the unit members 31a through 31c, which are spread by the user to a desired spread angle, is maintained by the static frictional forces unless any external force is applied to the unit members 31a through 31c.

The fastener 32, as shown in FIG. 3 and FIG. 4, is, for example, a bolt member 32 that is inserted into a through hole (h) formed at a distal end portion of the unit member 31a, 31c as shown in FIG. 4. The through hole (h) is formed as a threaded hole into which the bolt member 32 is screwed, and the unit members 31a and 31c at both ends are connected and the inner diameter of the pipe joint 3 can be expanded and contracted by screwing the bolt member 32 into the through hole (h). The bolt member 32 is provided with a stopper ring 7 arranged between the unit members 31a and 31c at both ends. In accordance with this configuration, the stopper ring 7 restricts the rotation of the unit members 31a, 31c when the pipe joint 3 is reduced to a predetermined inner diameter. In this state, the above-mentioned projections 14 formed on the distal end surfaces of a pair of the pipe members 1 bite into the gasket 2 so that airtightness between the distal end surfaces of a pair of the pipe members 1 is secured.

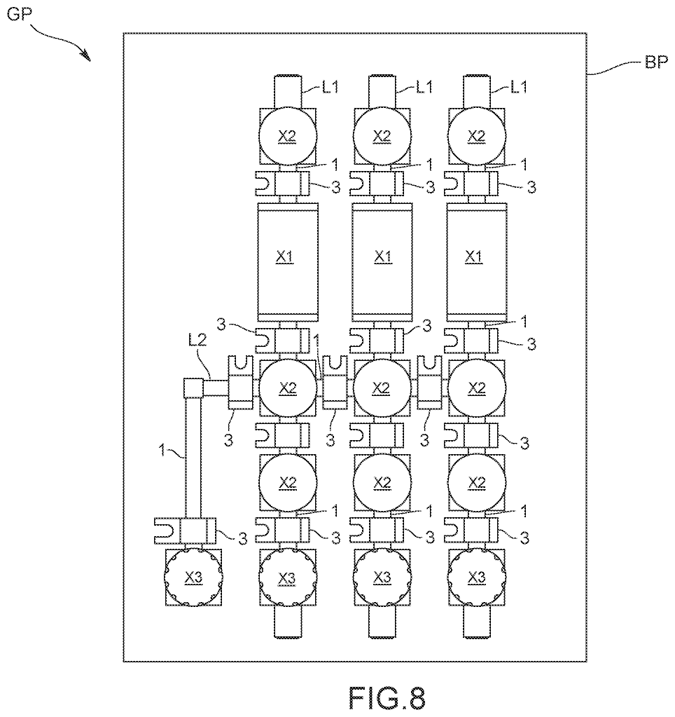

As shown in FIG. 8, the pipe joint 3 having the above-mentioned configuration can be used in a gas panel (GP) to be incorporated into, for example, a semiconductor manufacturing line.

This gas panel (GP) is made by integrating and arranging a plurality of fluid control units X1 through X3 such as flow meters or various sensors on a base plate (substrate) (BP) such as a manifold or the like.

The gas panel (GP) comprises, for example, one or a plurality of longitudinal fluid lines L1 arranged in parallel and one or a plurality of transverse fluid lines L2 arranged between the longitudinal fluid lines L1.

Various fluid control units such as a mass flow controller X1, a valve X2 and a fluid sensor X3 such as a pressure sensor and a heat sensor are densely arranged on the longitudinal fluid lines L1 and the transverse fluid lines L2, and the longitudinal fluid lines L1 and the transverse fluid lines L2 are so configured to produce a function as, for example, a gas supply line.

Then, the pipe joint 3 is used to connect connection ports of the fluid control units X1 through X3, which are arranged opposite to each other in the flow direction. More specifically, the pipe joint 3 in this embodiment is used to connect the pipe members 1 that are connected to the connection ports of the fluid control units X1 through X3, which are arranged opposite to each other in the flow direction, or used to connect the pipe member 1 to the connection ports of the fluid control units X1 through X3.

<Connection Method>

Next, a procedure for connecting a pair of the pipe members 1 using the above-mentioned pipe joint 3 will be described.

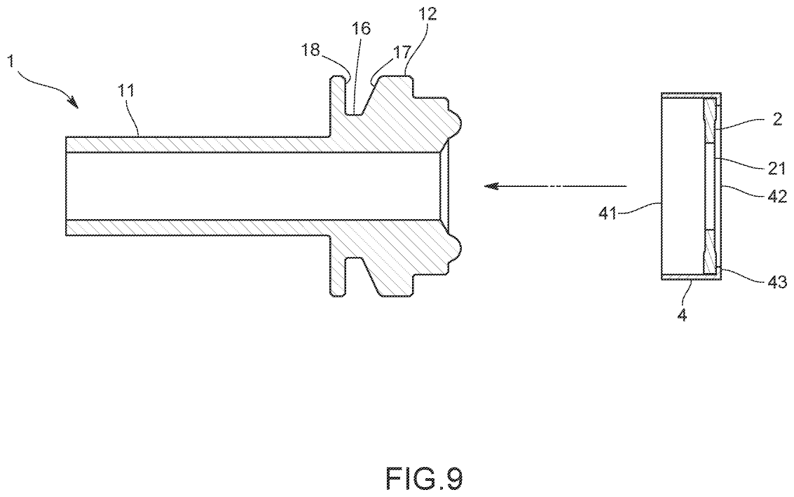

First, as shown in FIG. 9, a gasket holder 4 in which the gasket 2 is set (housed) is attached to the distal end of one of a pair of the pipe members 1.

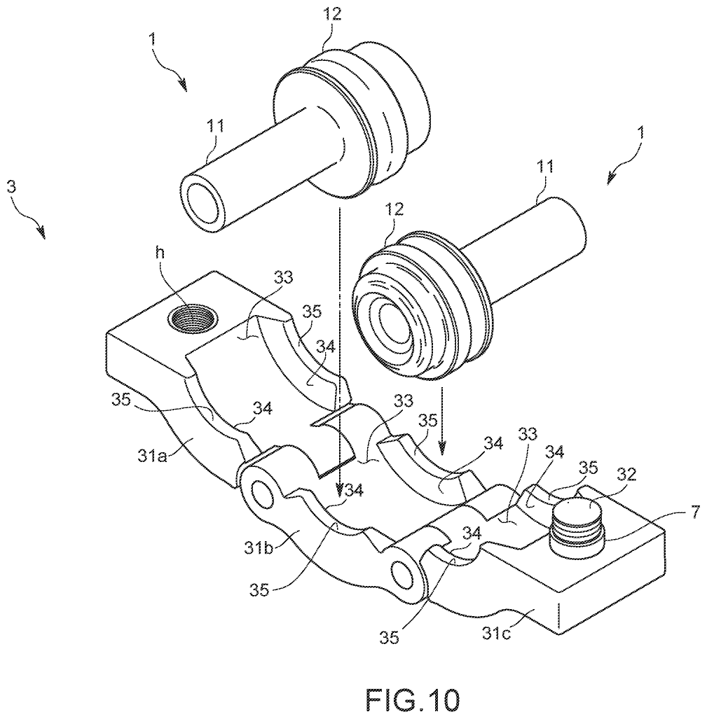

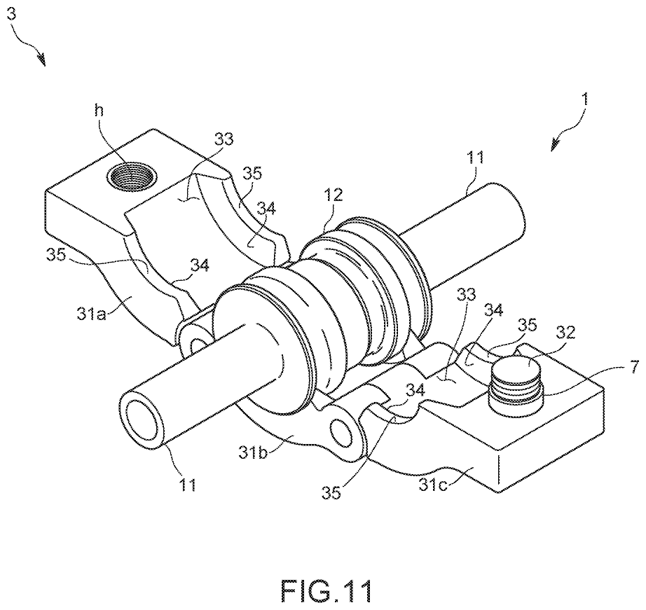

Next, as shown in FIG. 10 and FIG. 11, the flange portion 12 of one of the pipe members 1 is placed on, for example, one side in the axial direction of the center unit member 31b, and the flange portion 12 of the other pipe member 1 is placed on the other side in the axial direction of the same unit member 31b.

More concretely explained, the groove portion 15 arranged in the flange portion 12 of one of the pipe members 1 makes engagement with the convex portion 35 arranged in one side in the axial direction of the unit member 31b, and the groove portion 15 arranged in the flange portion 12 of the other pipe member 1 makes engagement with the convex portion 35 arranged in the other side in the axial direction of the unit member 31b.

At this time, various fluid control units X1 through X3 such as the above-mentioned gas panel (GP) are arranged in this embodiment. Since it is assumed that there is little space to move the pipe member 1 in the axial direction, it is preferable the groove portion 15 is engaged with the convex portion 35 by moving a pair of the pipe members 1 along the radial direction toward the unit member 31b, or by moving the unit member 31b along the radial direction toward a pair of the pipe members 1.

When the groove portion 15 and the convex portion 35 are engaged in this manner, a pair of the pipe members 1 are positioned against the unit member 31b and the groove portion 15 and the convex portion 35 function as the axial alignment mechanism 5 so that a pair of the pipe members 1 take the posture equivalent to the centering posture. The fluid control units X1 through X3 and the supporting members are arranged in advance so as to make the posture in the axial direction of the above-mentioned connection ports of the fluid control units, which is opposite to each other, approximately centered.

At this time, it is preferable to confirm that the flange portions 12 of the pipe members 1 are in a state of a position being able to make engagement with the unit members 31a through 31c by confirming that the misalignment of the center of a pair of the pipe members 1 is less than a predetermined value or that the inclination of the pipe members 1 is less than a predetermined angle. The confirming process may be to confirm drawing data such as CAD data or design data in a state wherein a pair of the pipe members 1 take the centering posture or a posture equivalent to the centering posture. It is preferable that the confirming process includes a step of manually or automatically measuring a size at a work site using a touch sensor or the like and calculating an amount of misalignment of a pair of the pipe members 1 based on the actually measured data and a step of judging whether or not the calculated value is less than a predetermined allowable value.

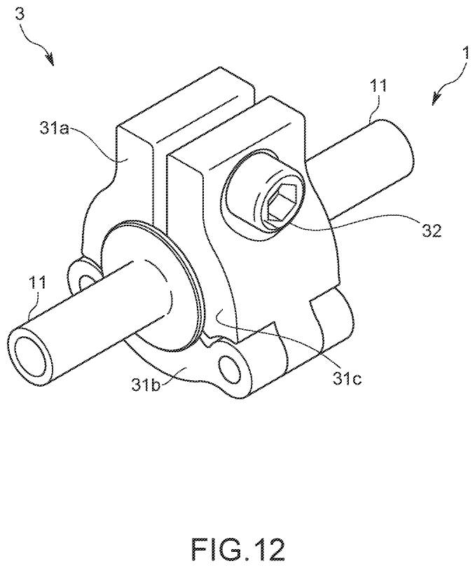

Next, as shown in FIG. 12, the unit members 31a, 31c locating at both ends are made in an annular state by connecting the unit members 31a and 31c by means of the fastener 32, and the inclined surface 17 of the groove portion 15 and the opposite inclined surfaces 34 of the convex portion 35 are pressed against each other by further fastening the fastener 32 to create a wedge effect between the inclined surfaces 17, 34 and the flange portions 12 of a pair of the pipe members 1 are crimp-connected to each other by the axial directional partial force generating at this time.

As a result of this, each of the above-mentioned projections 14 formed on the distal end surface of a pair of the pipe members 1 bites into the gasket 2 so that a pair of the pipe members 1 are airtightly and liquid-tightly joined together.

Furthermore, a pair of the pipe members 1 take the centering posture from the posture equivalent to the centering posture to the centering posture due to an axial directional partial force so that it is possible to make a pair of the pipe members 1 centered without moving them in the axial direction.

<Removal Method>

In case of removing one of a pair of the connected pipe members 1 from the pipe joint 3, first, the fastener 32 is loosened, and then a series of the unit members 31a through 31c that are fastened into an annular shape are opened to shape into a linear shape (state shown in FIG. 11).

Then, with this state kept, the pipe member 1 can be removed from the pipe joint 3 by moving (for example, lifting up) the pipe member 1 in the radial direction without moving the pipe member 1 in the axial direction.

In accordance with this connection method, if the groove portion 15 arranged in the flange portion 12 of each of a pair of the pipe members 1 is engaged with the convex portion 35 arranged in the unit member 31b, it is possible to make a pair of the pipe members 1 take the centering posture or the posture equivalent to the centering posture.

This enables centering of a pair of the pipe members 1 without using a ring-shaped member as described in the background art.

Until now, an assumption (or stereotypes and common sense in this field of the art) that a ring-shaped member is necessary for centering a pair of the pipe members 1 has not led to dramatic downsizing and higher integration of the gas panels (GP). However, with this invention, centering the pipe members 1 can be conducted without using any ring-shaped member. In case of removing the pipe member 1, since the pipe member 1 can be removed by lifting the pipe member 1, for example, in the radial direction without moving the pipe member 1 in the axial direction, it becomes possible to dramatically downsize and high integrate the gas panel (GP).

This invention is not limited to the above-mentioned embodiments.

For example, the above-mentioned embodiment describes how to remove the pipe members 1 without moving the pipe members 1 in the axial direction, however, it is a matter of course that the pipe joints 3 and the fluid control units X1 through X3 can also be removed without moving them in the axial direction.

In addition, in case of both connecting a pair of the pipe members 1 and removing the pipe members 1, the pipe member 1 may be moved toward the pipe joint 3, or the pipe joint 3 may be moved toward the pipe member 1. In this case, the direction of the movement is not necessarily be limited to the radial direction but may be inclined toward the axial direction as far as there is a space to allow some movement toward the axial direction.

Furthermore, in the above-mentioned embodiment, a case is explained that the groove portion 15 is arranged on the flange portion 12 of the pipe member 1 and the convex portion 35 is arranged on the unit members 31a through 31c, however, the convex portion 35 may be arranged on the flange portion 12 of the pipe member 1 and the groove portion 15 may be arranged on the unit members 31a through 31c.

In addition, the axial alignment mechanism 5 of the above-mentioned embodiment is so configured that a pair of the pipe members 1 take the posture equivalent to the centering posture by engaging the groove portion 15 with the convex portion 35. However, the groove 15 and the convex portion 35 may also be so configured that a pair of the pipe members 1 take the centering posture by engaging the groove portion 15 and the convex portion 35.

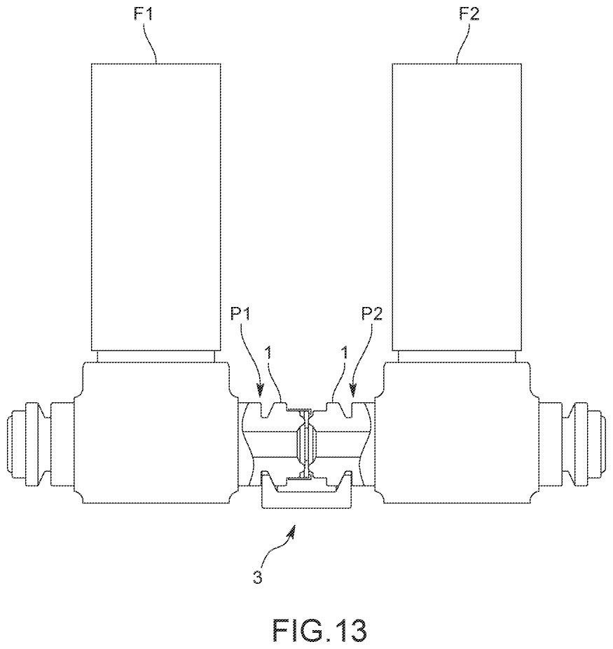

Furthermore, as shown in FIG. 13, one or both of a pair of the pipe members 1 may be not only for a piping itself but also for port portions of various fluid control units (F) such as flow meters and mass flow controllers, in other words, it may be a tubular connection portion to which the piping is connected in the fluid control units (F).

As a preferable example, in FIG. 13, connection ports P1 and P2 opposite to each other of a pair of the fluid control units F1 and F2 have the same shape. It is a matter of course that one of these connection ports P1 and P2 may be, for example, a tubular connection port member having an internal flow channel as shown in FIG. 9.

In addition, the gas panel (GP) as a fluid control device has been explained in the above description as being used in semiconductor manufacturing equipment, but it is not necessarily limited to this and can be used, for example, in gas analysis equipment.

Furthermore, as described above, in case of connecting the gas panel (GP) using the clamp joint of the present claimed invention to the pipe member 1 between a pair of the fluid control units opposite to each other, since an amount of misalignment and an amount of inclination of the opposite connection port are measured during or prior to assembling the gas panel (GP) and an installation work is performed after it is confirmed that these amounts fall within a predetermined allowable range, it becomes possible for installation operators to mount the device properly as far as the installation operators operates normally in accordance with the manual. In other words, it becomes possible for the installation operator to avoid backward and wasteful work until the assembly is completed.

In addition, the present claimed invention is not limited to the above-mentioned embodiments and may be variously modified or combined without departing from a spirit of the present claimed invention.

### POSSIBLE APPLICATIONS IN INDUSTRY

In accordance with the present claimed invention, it is possible to remove the pipe members that are joined together without moving them in the axial direction, but by moving them, for example, in the radial direction.

1. A connection method for connecting a pair of pipe members by means of a pipe joint, wherein
the pipe joint comprises a series of unit members each of which is rotatably connected to the adjacent one another and a fastener for connecting the unit members locating at both ends,
a pair of the pipe members take a centering posture or a posture equivalent to the centering posture by engaging a flange portion of each of a pair of the pipe members with both axial sides of the unit members, and
a pair of the pipe members are connected together in the centering posture by connecting the unit members locating at both ends using the fastener so to make the unit members in an annular state and by fastening the fastener.

2. The connection method described in claim 1, wherein
either of a groove portion extending in a circumferential direction or a convex portion extending in the circumferential direction is arranged on the flange portion of a pair of the pipe members,
the other of the groove portion extending in the circumferential direction or the convex portion extending in the circumferential direction is arranged on both axial sides of at least one of the unit members, and
a pair of the pipe members take the centering posture or the posture equivalent to the centering posture by engaging either of the groove portion and the convex portion arranged in the flange portion of each of a pair of the pipe members with the other of the groove portion or the convex portion arranged in the unit members.

3. The connection method described in claim 2, wherein
a pair of the pipe members take the centering posture or the posture equivalent to the centering posture by engaging the groove portion with the convex portion with a movement of the pipe member along the radial direction of the pipe member toward the unit member or a movement of the unit member along the radial direction of the pipe member toward the pipe member.

4. The connection method described in claim 2, wherein
the groove portions are arranged on each of the flange portions of a pair of the pipe members,
the convex portions are arranged at both axial sides of the unit members,
a surface of the groove portion opposite to the convex portion and a surface of the convex portion opposite to the groove portion are inclined surfaces in a state wherein the groove portion and the convex portion are engaged, and
the inclined surface of the groove portion and the inclined surface of the convex portion are pressed against each other by connecting the unit members locating at both ends using the fastener and by fastening the fastener and the flange portions of a pair of the pipe members are crimped and connected by a component force in the axial direction that generates at a time of fastening the fastener.

5. A connection method comprising
a process for preparing a pipe joint that comprises a series of unit members of which adjacent unit members are rotatably connected to each other and a fastener for connecting the unit members locating at both ends, wherein an inclined surface for producing a wedge effect by fastening the fastener is formed on an inner circumferential surface of the unit member,
a process for preparing a pair of pipe members having an inclined surface opposite to the inclined surface of the unit member,
a process for confirming that a pair of the pipe members take a centering posture or a posture equivalent to the centering posture, and
a process for connecting a pair of the pipe members by the fastener.

6. An axial alignment mechanism at a time of connecting a pair of pipe members by means of a pipe joint, and having a configuration that the pipe joint comprises a series of unit members of which adjacent unit members are rotatably connected to each other and a fastener for connecting the unit members locating at both ends, wherein comprising
a groove portion that is arranged in one of (i) the flange portion of a pair of the pipe members or (ii) at least one of the unit members and that extends in a circumferential direction, and
a convex portion that is arranged in the other of (i) the flange portion of the pair of the pipe members or (ii) at least one of the unit members and that extends in the circumferential direction and that engages with the groove portion, and
a pair of the pipe members are so configured to take a centering posture or a posture equivalent to the centering posture by engaging the groove portion with the convex portion.

7. The axial alignment mechanism described in claim 6, and configured to be without using a member by which a pair of the pipe members are fitted from the axial direction.

8. A connection method for connecting a pair of pipe members of a fluid control device and for connecting connection ports of a pair of the fluid control units arranged opposite to each other in a flowing direction of a fluid of the fluid control device wherein a plurality of fluid control units are integrated and arranged on a substrate, comprising
a process of preparing a joint body that comprises a series of unit members that are rotatably connected to each other and a fastening device that fastens both end portions of the unit members and in which an inclined surface that produces a wedge effect in accordance with a movement of fastening the unit members is formed on an inner circumferential side of each of the unit members, a process of preparing a pair of the pipe members at one end side of which a flange portion is formed and the other end side of which is connected to a connection port side of a pair of the fluid control units, and an opposite inclined surface that makes engagement with the inclined surface formed on the inner circumferential side of the unit member is formed on the flange portion,
a process of arranging a pair of the fluid control units and members to support the fluid control units so as to make a posture in the axial direction of the connection port of a pair of the fluid control devices opposed to each other in almost a centering state and confirming that a pair of the flange portions are in a state of being able to be engaged with the unit member, and
subsequently to the above-mentioned process for confirmation, a process of engaging the opposite inclined surface of the flange portion of a pair of the pipe members with the inclined surface of the inner circumferential side of the unit member and performing a fastening movement due to the fastening device.

9. The connection method for a pair of the pipe members of the fluid control device described in claim 8, wherein
the process for confirmation comprises
a step of calculating an amount of misalignment between a pair of the pipe members based on design data such as CAD data or actually measured data at the site using a touch sensor or the like, and
a step of judging that the calculated amount of misalignment is less than or equal to a predetermined allowable value.
